(19) United States
(12) Patent Application Publication
(10) Pub. No.: US 2026/0280384 A1
(43) Pub. Date: Sep. 17, 2026

(54) ELECTRIC MACHINE COOLANT GUIDE

(71) Applicant: GM GLOBAL TECHNOLOGY OPERATIONS LLC, Detroit, MI (US)

(72) Inventors: Goro TAMAI, Bloomfield Hills, MI (US); Maxwell WATTS, Troy, MI (US); David J. VARDA, West Bloomfield, MI (US); Bradford E. VORBECK, Clarkston, MI (US); Patrick S. PORTELL, Clarkston, MI (US)

(21) Appl. No.: 19/077,184

(22) Filed: Mar. 12, 2025

(51) Int. Cl. H02K 9/19

(52) U.S. Cl. CPC H02K 9/19

(57) ABSTRACT

An electric machine including: a rotor; a stator surrounding the rotor and defining an airgap between the rotor and the stator, the stator including a core and windings, ends of the windings protrude outward from the core; and an inner coolant guide adjacent to the core and surrounded by the ends of the windings. The inner coolant guide is configured to direct coolant applied to the ends of the windings away from the airgap, the inner coolant guide including: an upper flange having a first radius; a lower flange opposite to the upper flange, the lower flange having a second radius that is greater than the first radius; and openings defined between the upper flange and the lower flange configured to permit passage of coolant flowing along an outer surface of the upper flange onto an inner surface of the lower flange.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a coolant guide for an electric machine.

Electric machines include a rotor and a stator surrounding the rotor. The stator includes a core with windings wrapped around the core. Ends of the windings protrude outward from the core. During operation of the electric machine, coolant may be applied to the ends of the windings to cool the windings.

### SUMMARY

The present disclosure provides for, in various features, an electric machine including: a rotor; a stator surrounding the rotor and defining an airgap between the rotor and the stator, the stator including a core and windings, ends of the windings protrude outward from the core; and an inner coolant guide adjacent to the core and surrounded by the ends of the windings. The inner coolant guide is configured to direct coolant applied to the ends of the windings away from the airgap, the inner coolant guide including: an upper flange having a first radius; a lower flange opposite to the upper flange, the lower flange having a second radius that is greater than the first radius; and openings defined between the upper flange and the lower flange configured to permit passage of coolant flowing along an outer surface of the upper flange onto an inner surface of the lower flange.

In further features, a diverter is at a top of the upper flange, the diverter configured to direct coolant off of the upper flange and onto gears adjacent to the electric machine.

In further features, slots are defined by the lower flange and configured to permit coolant to pass from the inner surface of the lower flange onto the ends of the windings that are below the lower flange.

In further features, a radial rim includes an upper rim portion adjacent to the upper flange and a lower rim portion adjacent to the lower flange, the radial rim is between the core of the stator and each of the upper flange and the lower flange.

In further features, guide ribs are on an inside of the upper rim portion, the guide ribs are adjacent to the core and configured to direct the coolant from the upper rim portion to the lower rim portion.

In further features, the guide ribs are confined to the upper rim portion and terminate prior to the lower rim portion.

In further features, the guide ribs define a splitter at a top of the upper rim portion configured to direct flow of the coolant in opposite directions.

In further features, the lower rim portion is axially offset from the upper rim portion such that the upper rim portion is closer to the core than the lower rim portion.

In further features, mounts at upper rim portion and the lower rim portion are configured to mount the inner coolant guide to the core of the stator.

In further features, an outer coolant guide is adjacent to the core and surrounds both the ends of the windings and the inner coolant guide such that the ends of the windings are between the inner coolant guide and the outer coolant guide.

In further features, the outer coolant guide includes a coolant trough defining a plurality of fluid distribution holes in a base of the coolant trough, the coolant trough is opposite to the upper flange of the inner coolant guide and configured to distribute coolant collected by the coolant trough onto the ends of the windings by way of the fluid distribution holes.

In further features, the plurality of fluid distribution holes includes a first series of holes and a second series of holes, the first series of holes are closer to the core than the second series of holes and the first series of holes are larger than the second series of holes.

In further features, the base of the coolant trough further includes a plurality of ridges radially spaced apart along the base.

In further features, the base of the coolant trough includes a first sloped surface and a second sloped surface opposite to the first sloped surface, both the first sloped surface and the second sloped surface slopes downward to a bottom of the trough, the bottom defining a fluid flow path extending radially along the coolant trough, the fluid flow path is skewed to progressively shift further from the core in a counter-clockwise direction.

In further features, a shield extends from an inner wall of the coolant trough to over the core, the shield is angled to direct the coolant into the trough.

In further features, the outer coolant guide further includes a coolant basin opposite to the lower flange of the inner coolant guide, the coolant basin including a concave inner surface.

The present disclosure also provides for, in various features, an electric machine including: a rotor; a stator surrounding the rotor and defining an airgap between the rotor and the stator, the stator including a core and windings, ends of the windings protrude outward from the core; an inner coolant guide adjacent to the core and surrounded by the ends of the windings, the inner coolant guide configured to direct coolant applied to the ends of the windings away from the airgap; and an outer coolant guide adjacent to the core and surrounding both the ends of the windings and the inner coolant guide such that at least some of the ends of the windings are between the inner coolant guide and the outer coolant guide, the outer coolant guide including a coolant trough opposite to the inner coolant guide and configured to distribute coolant from the coolant trough onto at least the ends of the windings between the coolant trough and the inner coolant guide by way of fluid distribution holes defined by the coolant trough.

In further features, the inner coolant guide includes an upper flange, a lower flange, and openings defined between the upper flange and the lower flange configured to permit passage of coolant flowing along an outer surface of the upper flange onto an inner surface of the lower flange; the coolant trough is opposite to the upper flange of the inner coolant guide and the coolant trough is configured to distribute coolant onto at least the ends of the windings between the coolant trough and the upper flange by way of the fluid distribution holes defined by the coolant trough; and the outer coolant guide further includes a coolant basin opposite to the lower flange of the inner coolant guide, the coolant basin including a concave inner surface.

The present disclosure further provides for, in various features, a rotor; a stator surrounding the rotor and defining an airgap between the rotor and the stator, the stator including a core and windings, ends of the windings protrude outward from the core; an inner coolant guide adjacent to the core and surrounded by the ends of the windings, the inner coolant guide configured to direct coolant applied to the ends of the windings away from the airgap, the inner coolant guide including an upper flange, a lower flange, and openings defined between the upper flange and the lower flange configured to permit passage of coolant flowing along an outer surface of the upper flange onto an inner surface of the lower flange; and an outer coolant guide adjacent to the core and surrounding both the ends of the windings and the inner coolant guide such that at least some of the ends of the windings are between the inner coolant guide and the outer coolant guide. The outer coolant guide includes: a coolant trough opposite to the upper flange of the inner coolant guide and configured to distribute coolant from the coolant trough onto at least the ends of the windings between the coolant trough and the upper flange by way of fluid distribution holes defined by the coolant trough; and a coolant basin opposite to the lower flange of the inner coolant guide, the coolant basin including a concave inner surface.

In further features, the electric machine also includes: a diverter at a top of the upper flange of the inner coolant guide, the diverter configured to direct coolant off of the upper flange and onto gears adjacent to the electric machine; slots defined by lower flange configured to permit coolant to pass from the inner surface of the lower flange onto the ends of the windings that are below the lower flange; a radial rim including an upper rim portion adjacent to the upper flange and a lower rim portion adjacent to the lower flange, the radial rim is between the core of the stator and each of the upper flange and the lower flange; guide ribs on an inside of the upper rim portion, the guide ribs are adjacent to the core and configured to direct the coolant from the upper rim portion to the lower rim portion, the guide ribs are confined to the upper rim portion and terminate prior to the lower rim portion. The lower rim portion is axially offset from the upper rim portion such that the upper rim portion is closer to the core than the lower rim portion. The fluid distribution holes of the coolant trough include a first series of holes and a second series of holes, the first series of holes are closer to the core than the second series of holes and the first series of holes are larger than the second series of holes. A base of the coolant trough includes a first sloped surface and a second sloped surface opposite to the first sloped surface, both the first sloped surface and the second sloped surface slope downward to a bottom of the trough, the bottom defining a fluid flow path extending radially along the coolant trough, the fluid flow path skewed to progressively shift further from the core in a counter-clockwise direction.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an electric machine including an inner coolant guide and an outer coolant guide in accordance with the present disclosure;

FIG. 2 is a perspective view of the inner coolant guide and the outer coolant guide of FIG. 1 apart from the electric machine;

FIG. 3 is a perspective view of an inside of the inner coolant guide;

FIG. 4 is a side view of the inner coolant guide;

FIG. 5 is a top view of the outer coolant guide;

FIG. 6 is cross-sectional view of the inner coolant guide and the outer coolant guide, and ends of stator coils between the inner coolant guide and the outer coolant guide; and

FIG. 7 illustrates orientation of a coolant splitter of the inner coolant guide relative to the stator coils.

In the drawings, reference numbers may be reused to identify similar and/or identical elements.

### DETAILED DESCRIPTION

Electric machines generally include a rotor and a stator surrounding the rotor. An airgap is defined between the rotor and the stator. To cool windings of the stator, coolant may be sprayed onto ends of the windings. The present disclosure provides for coolant guides configured to direct the coolant away from the airgap. The coolant guides are configured to be attached to a core of the stator. An inner coolant guide is arranged within an inner diameter of the ends of the windings such that the inner coolant guide is surrounded by the ends of the windings. An outer coolant guide is arranged around an outer diameter of the ends of the windings such that the outer coolant guide surrounds the ends of the windings.

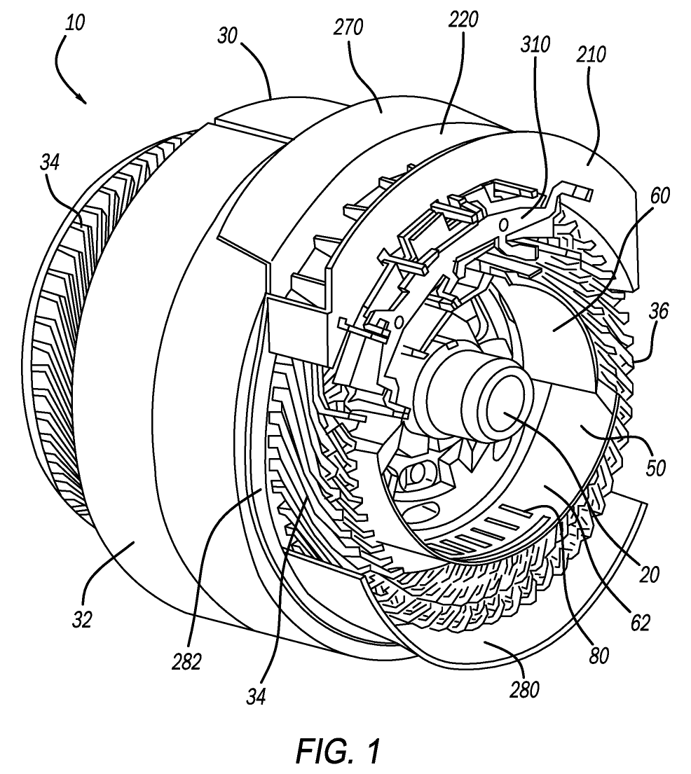

Although the present disclosure provides for both the inner coolant guide and the outer coolant guide, the inner coolant guide is sufficient to guide coolant away from the airgap without the use of the outer coolant guide. And the outer coolant guide is sufficient to guide coolant away from the airgap without the inner coolant guide. Thus, an electric machine in accordance with the present disclosure may include only the inner coolant guide without the outer coolant guide, or may include the outer coolant guide without the inner coolant guide. As illustrated in FIG. 1 and as described herein, both the inner coolant guide and the outer coolant guide may be attached to an electric machine to together direct coolant away from the airgap between the rotor and the stator.

FIG. 1 illustrates an example of an electric machine 10 in accordance with the present disclosure. The electric machine 10 may be any suitable motor-generator configured for any suitable automotive or nonautomotive use. With respective to automotive applications, the electric machine 10 may be configured as a motor-generator for fully electric vehicles or hybrid vehicles, for example. As a motor, the electric machine 10 is configured to convert electrical energy from a vehicle battery into mechanical energy to drive wheels of a vehicle. The electric machine 10 may also be configured to act as a generator during braking of the vehicle to convert kinetic energy back into electrical energy to recharge the vehicle battery – a process known as regenerative braking. The electric machine 10 may be configured for use as a generator onboard internal combustion engine vehicles as well. Suitable nonautomotive uses for the electric machine 10 include, but are not limited to, a standalone generator for supplying electricity for a variety of uses, such as to power a building, recharge batteries (such as vehicle batteries), power construction equipment, etc.

With continued reference to FIG. 1, the electric machine 10 generally includes a rotor 20 and a stator 30. The rotor 20 is configured to rotate within the stator 30. An airgap is defined between the rotor 20 and the stator 30. The stator 30 includes a core 32 and windings 34, which are wound about the core 32. Ends 36 of the windings 34 protrude outward from the core 32. During operation of the electric machine 10, the windings 34 may be cooled by spraying, or otherwise applying, any suitable coolant onto the ends 36 of the windings 34.

The present disclosure further provides for an inner coolant guide 50 and an outer coolant guide 210. As explained in detail herein, the inner coolant guide 50 and the outer coolant guide 210 are configured to direct coolant applied to the ends 36 of the windings 34 away from the airgap defined between the rotor 20 and the stator 30. Although the electric machine 10 is illustrated as including both the inner coolant guide 50 and the outer coolant guide 210, in accordance with the present disclosure the electric machine 10 may include only one of the inner coolant guide 50 and the outer coolant guide 210. More specifically, in accordance with the present disclosure the electric machine 10 may include only the inner coolant guide 50 and not include the outer coolant guide 210. Alternatively, the electric machine may include only the outer coolant guide 210 and not the inner coolant guide 50.

The coolant may be any suitable coolant, such as any suitable oil. Suitable oils include, but are not limited to, automatic transmission fluid. The inner coolant guide 50 and the outer coolant guide 210 are configured to direct the coolant to any suitable location, such as to a gear box adjacent to the electric machine 10 to lubricate the gears and to a sump for recirculation to the ends 36 of the windings 34. The electric machine 10 may include any suitable connector 310, such as a connection ring, configured to connect the windings 34 to a battery, for example.

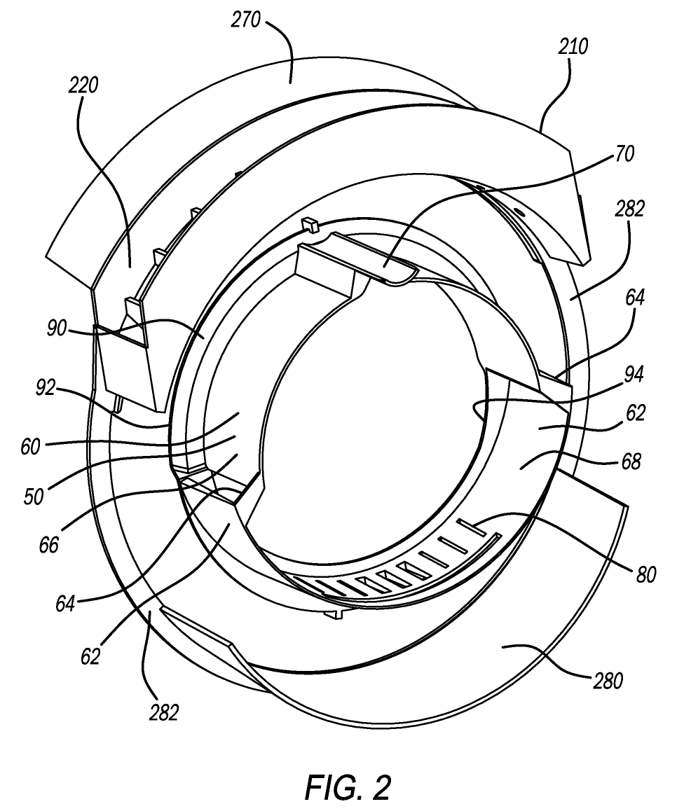

With continued reference to FIG. 1, and additional reference to FIGS. 2-4, the inner coolant guide 50 will now be described in detail. The inner coolant guide 50 is adjacent to the core 32 and is surrounded by the ends 36 of the windings 34. The inner coolant guide 50 generally includes an upper flange 60 and a lower flange 62 that is opposite to the upper flange 60.

Both the upper flange 60 and the lower flange 62 are curved. The upper flange 60 has a first radius and the lower flange 62 has a second radius that is greater than the first radius. Openings 64 are defined between the upper flange 60 and the lower flange 62. The openings 64 are configured to permit passage of coolant flowing along an outer surface 66 of the upper flange 60 onto an inner surface 68 of the lower flange 62.

The inner coolant guide 50 further includes a diverter 70. The diverter 70 is at a top of the upper flange 60. The diverter 70 may be configured in any suitable manner to guide the coolant away from the stator 30, such as to gears adjacent to the electric machine 10. In the example illustrated, the diverter 70 is configured as a curved surface extending beyond the upper flange 60.

The inner coolant guide 50 also includes slots 80 defined by the lower flange 62. The slots 80 are configured to permit coolant to pass from the inner surface 68 of the lower flange 62 onto the ends 36 of the windings 34 that are below the lower flange 62. Any suitable number and configuration of the slots 80 may be included. For example, a plurality of the slots 80 may be arranged to extend parallel to a longitudinal axis of the rotor 20. One or more of the slots 80 may extend generally perpendicular to the slots 80 extending parallel to the longitudinal axis of the rotor 20.

Also included with the inner coolant guide is a radial rim 90. The radial rim 90 includes an upper rim portion 92 and a lower rim portion 94. The upper rim portion 92 is adjacent to the upper flange 60 and the lower rim portion 94 is adjacent to the lower flange 62. The radial rim 90 is between the core 32 of the stator 30 and each of the upper flange 60 and the lower flange 62.

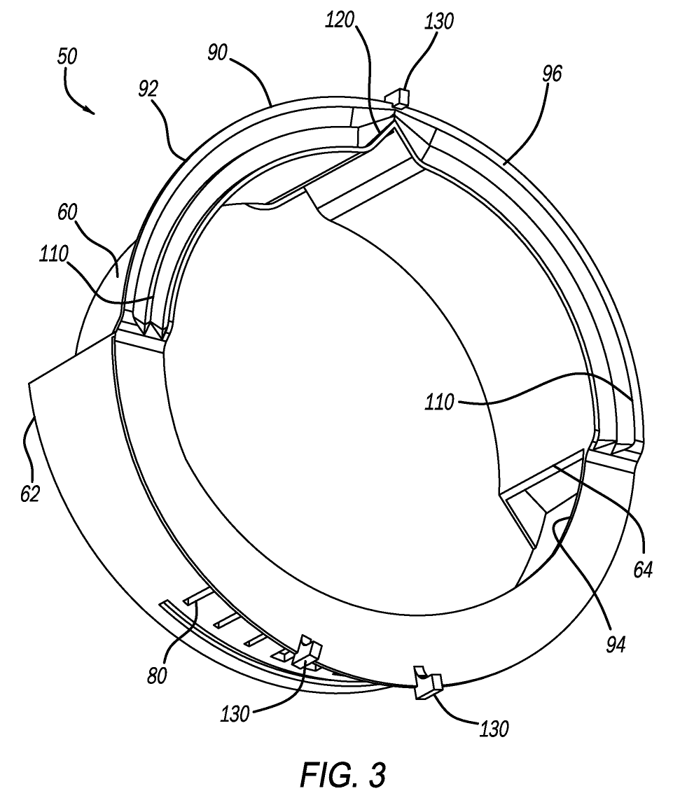

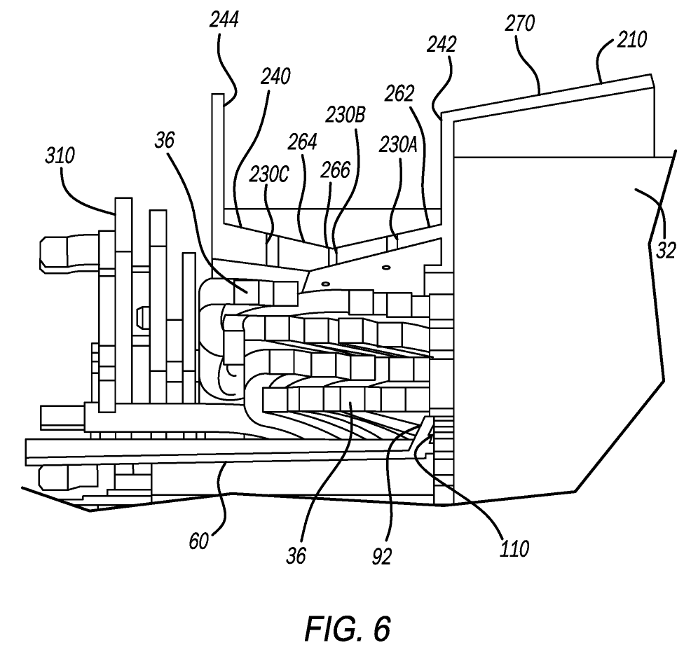

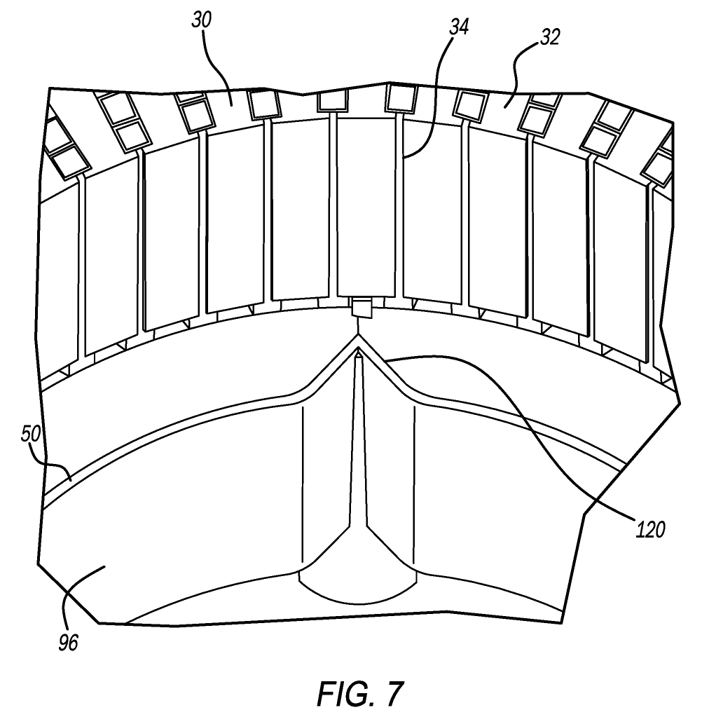

With particular reference to FIG. 3, at an inside 96 of the upper rim portion 92 are guide ribs 110. The guide ribs 110 may be any suitable guide surfaces configured to direct coolant from the upper rim portion 92 to the lower rim portion 94 on the inside 96 of the upper rim portion 92. The guide ribs 110 are adjacent to the core 32, as illustrated in FIG. 6 for example, and the guide ribs 110 are confined to the inside 96 of the upper rim portion 92. The guide ribs 110 define, or are adjacent to, a splitter 120 (FIGS. 3 and 7) at a top of the upper rim portion 92 on the inside 96 of the upper rim portion 92. The splitter 120 is any suitable surface configured to direct flow of the coolant off of the splitter 120 in opposite directions (to the left and to the right) into the guide ribs 110. With reference to the example of FIG. 7, the splitter 120 is arranged between straight bar sections of the windings 34 at a 12 o’clock position of the core 32.

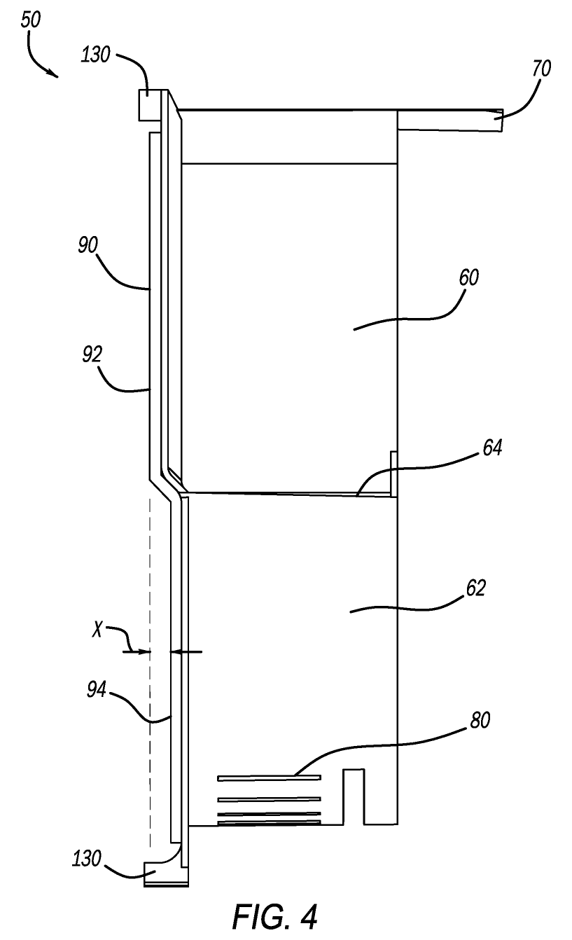

With reference to FIG. 4, the lower rim portion 94 is axially offset from the upper rim portion 92 such that the upper rim portion is closer to the core 32 than the lower rim portion 94. This axial offset is designated in FIG. 4 at X. The axial offset X provides a clearance between the lower rim portion 94 and the core 32 for coolant to accumulate without flowing into the core 32 and into the airgap between the rotor 20 and the core 32. More specifically, any coolant that may have passed over the radial rim 90 into an area between the radial rim 90 and the core 32 is trapped by the guide ribs 110 and directed by the guide ribs 110 downward to the lower rim portion 94 away from the stator 30. To accommodate the coolant directed to the lower rim portion 94 (which does not include the guide ribs 110), the lower rim portion 94 is axially offset relative to the upper rim portion 92 by the axial offset X, which may be any suitable distance sufficient to accommodate coolant directed to the lower rim portion 94 by the guide ribs 110.

The inner coolant guide 50 is mounted to the core 32 in any suitable manner to place the inside 96 of the inner coolant guide 50 against the core 32 and within the ends 36 of the windings 34, as illustrated in FIGS. 1 and 6, for example. The inner coolant guide 50 may include, for example, mounts 130 at both the upper rim portion 92 and the lower rim portion 94. The mounts 130 may be configured in any suitable manner. For example, the mounts 130 may be configured as flanges configured to cooperate with any suitable fasteners for fastening the inner coolant guide 50 to the core 32. In the example illustrated, the inner coolant guide includes one of the mounts 130 at a top of the upper rim portion 92 on the inside thereof, and two of the mounts 130 at a bottom of the lower rim portion 94 in the inside thereof. With particular reference to FIG. 4, the mounts 130 at the lower rim portion 94 are configured to accommodate the axial offset X and to space the lower rim portion 94 from the core 32 to accommodate accumulation of coolant from the guide ribs 110 at the lower rim portion 94 in the area of the axial offset X.

With reference to FIGS. 1, 2, 5, and 6, the outer coolant guide 210 will now be described in detail. The outer coolant guide 210 is adjacent to the core 32 and surrounds both the ends 36 of the windings 34 and the inner coolant guide 50 such that the ends 36 of the windings 34 are between the outer coolant guide 210 and the inner coolant guide 50. The outer coolant guide 210 is mounted to the core 32 in any suitable manner, such as with any suitable fasteners.

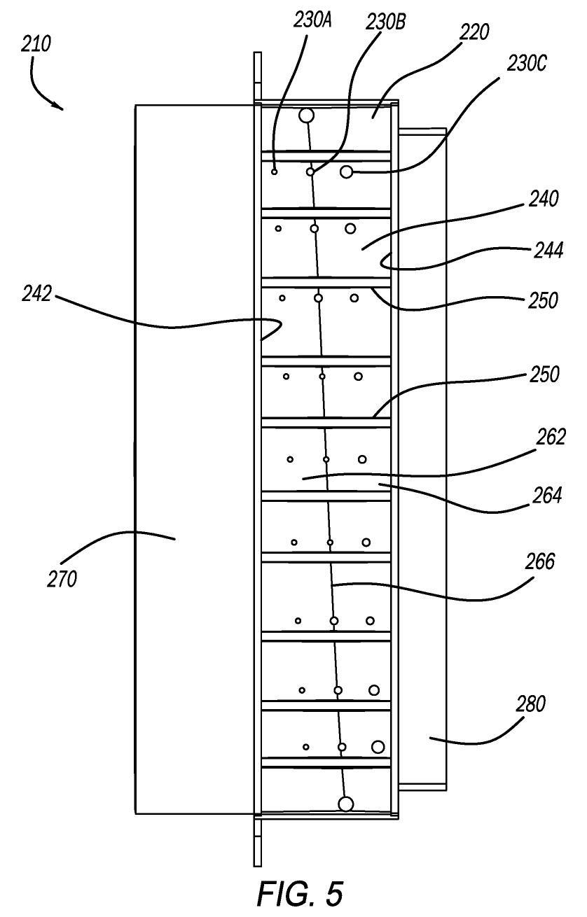

The outer coolant guide 210 includes a coolant trough 220. The coolant trough 220 is opposite to the upper flange 60 of the inner coolant guide 50, and is configured to distribute coolant collected by the coolant trough 220 onto the ends 36 of the windings 34 by way of first fluid distribution holes 230A, second fluid distribution holes 230B, and third fluid distribution holes 230C defined in a base 240 of the coolant trough 220. The base 240 is between an inner wall 242 and an outer wall 244 defining the coolant trough (FIGS. 5 and 6). Spaced apart along the base 240 are ridges 250. In the example illustrated, the ridges 250 are evenly and radially spaced apart. The ridges 250 are configured to slow coolant flow along the base 240 to facilitate flow of the coolant through the first fluid distribution holes 230A, the second fluid distribution holes 230B, and the third fluid distribution holes 230C.

The base 240 includes a first sloped surface 262 and a second sloped surface 264 opposite to the first sloped surface 262. With particular reference to FIG. 6, the first sloped surface 262 slopes downward from the inner wall 242 and the second sloped surface 264 slopes downward from the outer wall 244. Both the first sloped surface 262 and the second sloped surface 264 slope downward to a bottom 266 of the coolant trough 220. With particular reference to FIG. 5, the bottom 266 defines a fluid flow path extending radially along the coolant trough 220 that is skewed to progressively shift further from the core 32 in a counter-clockwise direction. As a result, the bottom 266 directs fluid away from windings 34 (and the ends 36 thereof) that are angled in a direction that may be more likely to direct coolant into the airgap between the rotor 20 and the stator 30, such as the windings 34 at about a 10 o’clock position about the core 32.

The first fluid distribution holes 230A, the second fluid distribution holes 230B, and the third fluid distribution holes 230C are also configured to direct coolant flow away from windings 34 at the 10 o-clock position. The positioning of the first fluid distribution holes 230A, the second fluid distribution holes 230B, and the third fluid distribution holes 230C generally follows the skewed fluid flow path defined by the bottom 266 of the coolant trough 220. In the example of FIG. 5, the plurality of fluid distribution holes includes the first fluid distribution holes 230A, the second fluid distribution holes 230B, and the third fluid distribution holes 230C.

The first fluid distribution holes 230A are closer to the core 32, and relatively smaller in diameter, than each of the second fluid distribution holes 230B and the third fluid distribution holes 230C. The third fluid distribution holes 230C are further from the core 32, and relatively larger in diameter, than each of the first fluid distribution holes 230A and the second fluid distribution holes 230B. The second fluid distribution holes 230B are located between the first fluid distribution holes 230A and the third fluid distribution holes 230C. The second fluid distribution holes 230B are larger in diameter than the first fluid distribution holes 230A, and smaller in diameter than the third fluid distribution holes 230C. The first fluid distribution holes 230A, the second fluid distribution holes 230B, and the third fluid distribution holes 230C are all arranged in an orientation that progressively shifts outward and away from the core 32 in the counter-clockwise direction, as illustrated in FIG. 5. The second fluid distribution holes 230B are generally at, or closest to, the bottom 266 of the coolant trough 220.

The outer coolant guide 210 also includes a shield 270, which covers at least a portion of the core 32. In the example illustrated, the shield 270 extends from the inner wall 242 of the coolant trough 220. The shield 270 and curved, and covers an end of the core 32 that the outer coolant guide 210 is attached to. The shield 270 is angled towards the coolant trough 220 to direct coolant into the coolant trough 220.

The outer coolant guide 210 further includes a coolant basin 280. The coolant basin 280 is opposite to the coolant trough 220 to collect coolant flowing from the coolant through 220. The coolant basin 280 may be connected to the coolant trough 220 by a connector ring 282, for example. The coolant basin 280 includes a concave inner surface configured to collect coolant and direct the coolant away from the airgap between the rotor 20 and the stator 30. As illustrated in FIGS. 1 and 2, the coolant basin 280 is opposite to the lower flange 62 to collect coolant that may have passed through the slots 80.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An electric machine comprising:
a rotor;
a stator surrounding the rotor and defining an airgap between the rotor and the stator, the stator including a core and windings, ends of the windings protrude outward from the core; and
an inner coolant guide adjacent to the core and surrounded by the ends of the windings, the inner coolant guide configured to direct coolant applied to the ends of the windings away from the airgap, the inner coolant guide including:
an upper flange having a first radius;
a lower flange opposite to the upper flange, the lower flange having a second radius that is greater than the first radius; and
openings defined between the upper flange and the lower flange configured to permit passage of coolant flowing along an outer surface of the upper flange onto an inner surface of the lower flange.

2. The electric machine of claim 1, further comprising a diverter at a top of the upper flange, the diverter configured to direct coolant off of the upper flange and onto gears adjacent to the electric machine.

3. The electric machine of claim 1, further comprising slots defined by the lower flange configured to permit coolant to pass from the inner surface of the lower flange onto the ends of the windings that are below the lower flange.

4. The electric machine of claim 1, further comprising a radial rim including an upper rim portion adjacent to the upper flange and a lower rim portion adjacent to the lower flange, the radial rim is between the core of the stator and each of the upper flange and the lower flange.

5. The electric machine of claim 4, further comprising guide ribs on an inside of the upper rim portion, the guide ribs are adjacent to the core and configured to direct the coolant from the upper rim portion to the lower rim portion.

6. The electric machine of claim 5, wherein the guide ribs are confined to the upper rim portion and terminate prior to the lower rim portion.

7. The electric machine of claim 5, wherein the guide ribs define a splitter at a top of the upper rim portion configured to direct flow of the coolant in opposite directions.

8. The electric machine of claim 5, wherein the lower rim portion is axially offset from the upper rim portion such that the upper rim portion is closer to the core than the lower rim portion.

9. The electric machine of claim 5, further comprising mounts at upper rim portion and the lower rim portion configured to mount the inner coolant guide to the core of the stator.

10. The electric machine of claim 1, further comprising an outer coolant guide adjacent to the core and surrounding both the ends of the windings and the inner coolant guide such that the ends of the windings are between the inner coolant guide and the outer coolant guide.

11. The electric machine of claim 10, wherein the outer coolant guide includes a coolant trough defining a plurality of fluid distribution holes in a base of the coolant trough, the coolant trough is opposite to the upper flange of the inner coolant guide and configured to distribute coolant collected by the coolant trough onto the ends of the windings by way of the fluid distribution holes.

12. The electric machine of claim 11, wherein the plurality of fluid distribution holes includes a first series of holes and a second series of holes, the first series of holes are closer to the core than the second series of holes and the first series of holes are larger than the second series of holes.

13. The electric machine of claim 11, wherein the base of the coolant trough further includes a plurality of ridges radially spaced apart along the base.

14. The electric machine of claim 11, wherein the base of the coolant trough includes a first sloped surface and a second sloped surface opposite to the first sloped surface, both the first sloped surface and the second sloped surface slopes downward to a bottom of the trough, the bottom defining a fluid flow path extending radially along the coolant trough, the fluid flow path is skewed to progressively shift further from the core in a counter-clockwise direction.

15. The electric machine of claim 11, further comprising a shield extending from an inner wall of the coolant trough to over the core, the shield is angled to direct the coolant into the trough.

16. The electric machine of claim 10, wherein the outer coolant guide further includes a coolant basin opposite to the lower flange of the inner coolant guide, the coolant basin including a concave inner surface.

17. An electric machine comprising:
a rotor;
a stator surrounding the rotor and defining an airgap between the rotor and the stator, the stator including a core and windings, ends of the windings protrude outward from the core;
an inner coolant guide adjacent to the core and surrounded by the ends of the windings, the inner coolant guide configured to direct coolant applied to the ends of the windings away from the airgap; and
an outer coolant guide adjacent to the core and surrounding both the ends of the windings and the inner coolant guide such that at least some of the ends of the windings are between the inner coolant guide and the outer coolant guide, the outer coolant guide including a coolant trough opposite to the inner coolant guide and configured to distribute coolant from the coolant trough onto at least the ends of the windings between the coolant trough and the inner coolant guide by way of fluid distribution holes defined by the coolant trough.

18. The electric machine of claim 17, wherein:
the inner coolant guide includes an upper flange, a lower flange, and openings defined between the upper flange and the lower flange configured to permit passage of coolant flowing along an outer surface of the upper flange onto an inner surface of the lower flange;
the coolant trough is opposite to the upper flange of the inner coolant guide and the coolant trough is configured to distribute coolant onto at least the ends of the windings between the coolant trough and the upper flange by way of the fluid distribution holes defined by the coolant trough; and
the outer coolant guide further includes a coolant basin opposite to the lower flange of the inner coolant guide, the coolant basin including a concave inner surface.

19. An electric machine comprising:
a rotor;
a stator surrounding the rotor and defining an airgap between the rotor and the stator, the stator including a core and windings, ends of the windings protrude outward from the core;
an inner coolant guide adjacent to the core and surrounded by the ends of the windings, the inner coolant guide configured to direct coolant applied to the ends of the windings away from the airgap, the inner coolant guide including an upper flange, a lower flange, and openings defined between the upper flange and the lower flange configured to permit passage of coolant flowing along an outer surface of the upper flange onto an inner surface of the lower flange; and
an outer coolant guide adjacent to the core and surrounding both the ends of the windings and the inner coolant guide such that at least some of the ends of the windings are between the inner coolant guide and the outer coolant guide, the outer coolant guide including:
a coolant trough opposite to the upper flange of the inner coolant guide and configured to distribute coolant from the coolant trough onto at least the ends of the windings between the coolant trough and the upper flange by way of fluid distribution holes defined by the coolant trough; and
a coolant basin opposite to the lower flange of the inner coolant guide, the coolant basin including a concave inner surface.

20. The electric machine of claim 19, further comprising:
a diverter at a top of the upper flange of the inner coolant guide, the diverter configured to direct coolant off of the upper flange and onto gears adjacent to the electric machine;
slots defined by lower flange configured to permit coolant to pass from the inner surface of the lower flange onto the ends of the windings that are below the lower flange;
a radial rim including an upper rim portion adjacent to the upper flange and a lower rim portion adjacent to the lower flange, the radial rim is between the core of the stator and each of the upper flange and the lower flange;
guide ribs on an inside of the upper rim portion, the guide ribs are adjacent to the core and configured to direct the coolant from the upper rim portion to the lower rim portion, the guide ribs are confined to the upper rim portion and terminate prior to the lower rim portion;
wherein the lower rim portion is axially offset from the upper rim portion such that the upper rim portion is closer to the core than the lower rim portion;
wherein the fluid distribution holes of the coolant trough include a first series of holes and a second series of holes, the first series of holes are closer to the core than the second series of holes and the first series of holes are larger than the second series of holes; and
wherein a base of the coolant trough includes a first sloped surface and a second sloped surface opposite to the first sloped surface, both the first sloped surface and the second sloped surface slope downward to a bottom of the trough, the bottom defining a fluid flow path extending radially along the coolant trough, the fluid flow path skewed to progressively shift further from the core in a counter-clockwise direction.
